(19) United States
(12) Patent Application Publication
(10) Pub. No.: US 2002/0104789 A1
(43) Pub. Date: Aug. 8, 2002

(54) Top of grate catch basin filter

(76) Inventors: John F. Harris, Albany, OR (US); Ardle E. Page, Albany, OR (US)

Correspondence Address: John F. Harris, 1464 Ridgeview PL., N.W., Albany, OR, 97321, US

(21) Appl. No.: 09/778,360

(22) Filed: Feb. 7, 2001

(51) Int. Cl. B01D 35/28

(52) U.S. Cl. 210/162

(57) ABSTRACT

A removable filter for in ground catch basins. The present invention includes a catch basin, a top grate, a filter and an attachment of the filter to the top grate. The filter removes solids from the storm water prior to the storm water passing through the grate. It includes an overflow bypass which is compressible and thereby safe for traffic.

### Patent Application

### of

### John F. Harris and Ardle E. Page

### For

### Top of Grate Catch Basin Filter

### References Cited

U.S. Patent Documents

Logue U.S. Pat. No. 5,372,714 Dec. 13, 1994

Logue U.S. Pat. No. 5,575,925 Nov. 19,1995

Chinn, et al. U.S. Pat. No. 5,632,888 May 27, 1997

Sharpless U.S. Pat. No. 5,849,198 Dec. 15, 1998

Strawser Sr. U.S. Pat. No. 5,954,952 Sep. 21, 1999

Allen, et al. U.S. Pat. No. 6,015,489 Jan. 18,2000

McDermott U.S. Pat. No. 6,045,691 Apr. 4, 2000

Bennett U.S. Pat. No. 6,096,200 Aug. 1, 2000

Other Publications

Hydraulics Manual Volume 2, Erosion and Sediment Control Oregon Department of Transportation, December 1999

### FIELD OF THE INVENTION

The invention relates to filters for storm water catch basins.

### DESCRIPTION OF THE PRIOR ART

This invention relates to a filter for use on a storm sewer catch basin equipped with a top grate. The ground water flows through the filter into the grate and catch basin, and then out the sewer line. Before the ground water flows into the sewer line solid pollutants need to be filtered out of the storm water. Most catch basin filtration systems are not immediately upstream from drain grates or are not designed for catch basins with a single grate inlet cover. In the past, filtration has been accomplished using devices which are downstream and below the grate. Most are labor intensive being constructed on site. Caldwell (U.S. Pat No. 1,310,055) strains out only large debris such as sticks and leaves. The modern regulations require that much smaller solids such as sand or silt are removed from storm water. Chinn, et. al. (U.S. Pat. No. 5,632,888) and McDermott (U.S. Pat. No. 6,045,691) developed a filter upstream from the catch basin chamber but they are designed for curb inlets only and not for a catch basin top with a grate covering. Allen, et al (U.S. Pat. No. 6,015,489), Sharpless (U.S. Pat. No. 5,849,198), Bennett (U.S. Pat. No. 6,096,200), Logue (U.S. Pat. No. 5,575,925) and Logue (U.S. Pat. No. 5,372,714), all develop filtration systems which position the filter apparatus down stream from the inlet opening grate. These are labor intensive to install and maintain. Strawser Sr. (U.S. Pat. No. 5,954,952) develops a filtration system for catch basins with a curb inlet combined with a gutter inlet. This is not refer a single grate inlet as in our invention.

Faneli (U.S. Pat. No. 5,733,445) comprises a thin support grate on top of the inlet grate. The support grate is fabricated from metallic material such as steel. This is expensive to manufacture and no overflow by pass is included.

Best management practices in Oregon Department of Transportation BMP Manual December 1999 pages 3-78 to 3-83 include inlet protection filtration systems which are upstream from a catch basin grate. All such included systems are to be constructed on site. A filtration system on top of a grate is shown on page 3-78. This shows a need for such a filter These on sight fabrications are labor intensive and of inconsistent quality. As described, they are a traffic hazard when placed in a street and have no overflow provision for high flow conditions. There is a need for a prefabricated filter which mounts on the top of a catch basin. No catch basin filtration system which essentially rests on top of the grate includes an overflow by pass which is also safe for traffic. For the foregoing reasons there is need for such a storm water catch basin filter

### SUMMERY OF THE INVENTION

Our invention is a removable filter for a storm sewer catch basin which is equipped with a removable top inlet grate. The filter is essentially located on top of the catch basin grate. The filter is typically composed of a porous geo textile fabric which covers the grate inlet. Pollutant solids are held back while the water is allowed to freely flow into the catch basin through the grate. The filter enwraps the grate thereby preventing storm water from entering the grate without passing through the filter. The filter includes a centrally located by pass opening. A wall barrier protects the opening and, during low flows, forces the water to enter the grate only through the surrounding filtration fabric. The wall is limited in height. During high water conditions the water flows over this low wall and into the catch basin. This wall is made of a compressible material such as foam rubber and easily flattens with traffic weight The filter therefore poses little threat to traffic safety. The wall springs the by pass opening top back to its former position when it is no longer weighed down.

### DESCRIPTION OF THE DRAWINGS

FIG. 1 is a top view of the filter inserted in a catch basin. FIG. 2. Is a bottom view of the filter attached to the grate with an outer edge of the filter enwrapping the inlet grate. FIG. 3. is a sectional view taken along lines 2-2. of FIG. 1.

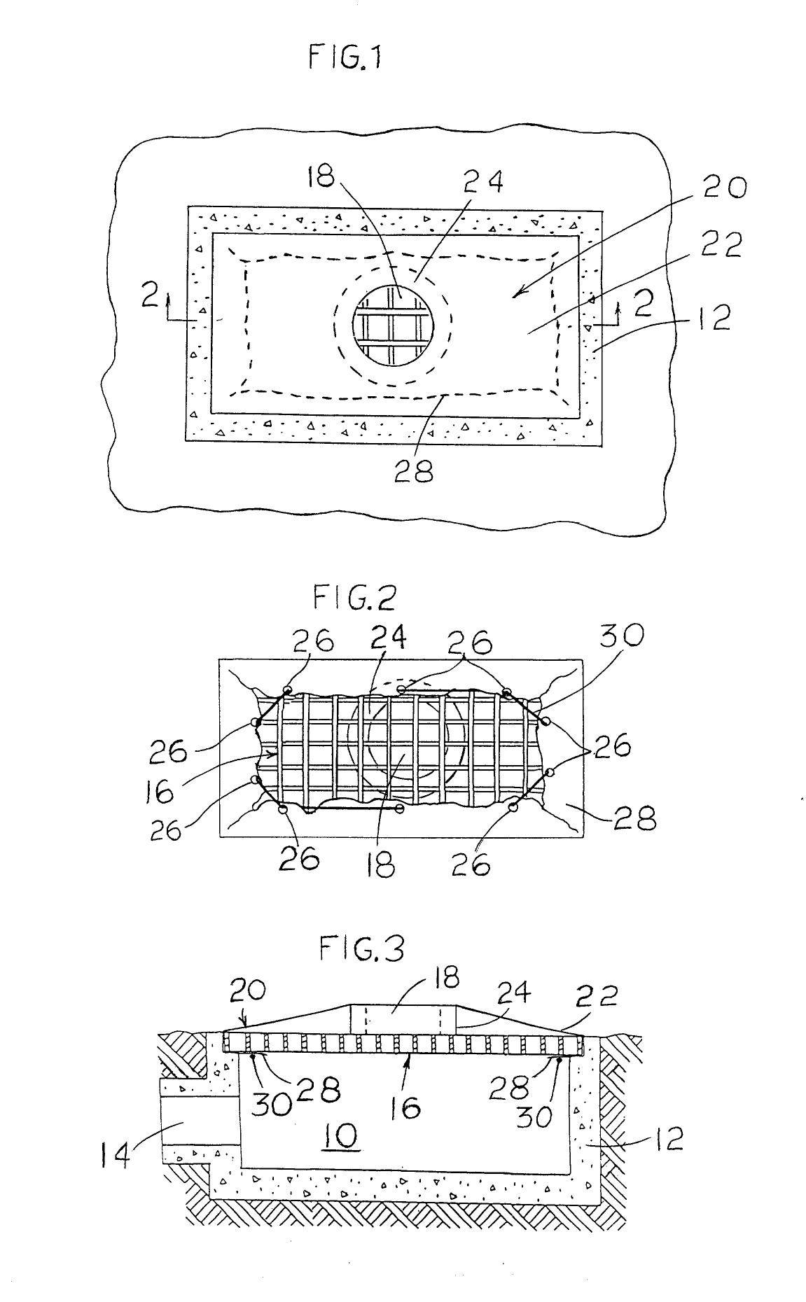

### DESCRIPTION OF THE PREFERRED EMBODIMENT

Catch basin chamber 10 is defined by a concrete catch basin enclosure 12. Concrete storm sewer pipe outlet 14 extends away from the enclosure. Rectangular inlet grate 16 closes the top of the catch basin. Ground water flows through a filter 20, through the grate, into the catch basin chamber, and out the outlet.

Catch basin filter 20 includes a filter fabric 22, and an overflow inlet 18. When the filter is in place, storm water flows through the filter prior to flowing into an inlet grate 16. The filter fabric is typically made of a non-woven polypropylene fabric. This fabric holds back solids while allowing storm water to pass freely through the filter. The filter comprises a centrally located overflow opening 18. This opening allows storm water to flow over the over flow wall 24, through the grate, into the catch basin chamber during high water levels. The overflow wall supports and maintains the opening at a higher elevation than the surrounding filter fabric During normal water flow, the barrier wall prevents water from flowing into the over flow opening. The wall typically comprises foam rubber. This allows the wall to essentially flatten under traffic weight and then return to its original height when the weight departs. The filter fabric has an outer filter edge 28. When in use the filter is attached to the grate by enwrapping the edge around the grate. A pull cord 30 pulls the outer edge around the grate. When the cord is tied, it holds the filter in place around the grate. The pull cord is pulled through grommets 26

When inserting the filter into the catch basin for use, the grate is removed from through the filter. The filter comprises a centrally located overflow opening 18. This opening allows storm water to flow over the over flow wall 24, through the grate, into the catch basin chamber during high water levels. The overflow wall supports and maintains the opening at a higher elevation than the surrounding filter fabric. During normal water flow, the barrier wall prevents water from flowing into the over flow opening. The wall typically comprises foam rubber. This allows the wall to essentially flatten under traffic weight and then return to its original height when the weight departs. The filter fabric has an outer filter edge 28. When in use the filter is attached to the grate by enwrapping the edge cord is tied, it holds the filter in place around the grate. The pull cord is pulled through grommets 26.

When inserting the filter into the catch basin for use, the grate is removed from the catch basin, the filter is wrapped around the grate, and the grate is reinserted into the catch basin. To remove the filter, the grate is lifted up and out of the catch basin and the pull cord is released allowing the grate to separate from the filter. While we have illustrated and described a preferred embodiment of our invention, we wish to not be thereby limited to this preferred embodiment, but wish to include such changes and variations as fall within the scope of the following claims.

What we claim as our invention is:

1. The combination comprising:
a) a catch basin chamber including,
1) an inlet through which storm water and pollutants flow into the catch basin,
2) and a catch basin outlet through which water flows out of the catch basin chamber,
3) A catch basin grate covering the catch basin inlet,
b) an apparatus comprising;
1) a catch basin filter which is essentially located on the top of the grate,
2) and an over flow by pass opening.

2. The apparatus according to claim 1 further comprises an attachment to the grate which essentially encircles said grate.

3. The catch basin filter of claim 1 further comprising a geo textile fabric.

4. The fabric of claim 1 further comprises an outer edge, a pull cord and grommets.

5. The fabric of claim 3 further comprises non woven polypropylene.

6 The apparatus according to claim 1 further comprising a filter overflow inlet with an overflow wall that raises the opening to a higher elevation than the surrounding filter.

7. The filter overflow inlet of claim 6 further includes an opening wall structure which is retractable and essentially flattens under weight, and returns the opening to its former elevation when relieved of said weight and is thereby safe for road traffic.

9. The opening wall structure of claim 7 further comprises a foam rubber support.

10. The opening wall structure of claim 7 further comprises a floatation support.

11. The support of claim 7 further comprises an air inner tube.

12. The combination comprising:
a) a catch basin including,
1) a catch basin chamber
2) an inlet through which storm water and pollutants flow into the catch basin,
3) an outlet through which water flows out of the catch basin,
4) a catch basin grate which covers the catch basin inlet,
b) and an apparatus comprising,
1) a filter which is essentially located on the top of the grate,
2) a water by passing means which comprises,
a) a by pass opening to the catch basin,
b) a flow barrier wall around the opening which limits water flow inlet during low flow rates, and
c) a low limited elevation of said wall which allows water to flow over the top of the wall into the catch basin during high water levels.

12. The flow barrier wall of claim 11 wherein the wall further comprises a compressing means that combines the by pass opening with material which easily drops in elevation and essentially flattens under the weight of traffic and returns the by pass opening to its original height when relieved of traffic.

13. The flow barrier wall of claim 12 wherein the material for a compression means comprises foam rubber.

14. The flow barrier wall of claim 12 wherein the wall further comprises a floating means which floats on the storm water and adjusts the level of the by pass opening and rises only up to a certain point and then allows water to overflow into the opening.

15. The filter of claim 11 which further comprises an attachment means which couples the filter to the grate by encircling said grate.

16. The attachment means of claim 11 further includes a pull cord, that pulls through grommets.

17. The filtering means of claim 11 further comprises non woven filtration fabric.
